(19) United States
(12) Patent Application Publication
(10) Pub. No.: US 2006/0008581 A1
(43) Pub. Date: Jan. 12, 2006

(54) Method of manufacturing an electrochemical sensor

(76) Inventors: Mark Hyland, Oxfordshire (GB); Kevin Lorimer, Oxfordshire (GB); Charles Richard Wedge, Oxfordshire (GB); John Morton Broughall, Oxfordshire (GB); Ronald Neil Butler, Oxfordshire (GB)

Correspondence Address: QUARLES & BRADY LLP, 411 E. WISCONSIN AVENUE, SUITE 2040, MILWAUKEE, WI, 53202-4497, US

(21) Appl. No.: 11/154,799

(22) Filed: Jun. 16, 2005

Related U.S. Application Data
(60) Provisional application No. 60/586,834, filed on Jul. 9, 2004.

(51) Int. Cl. B05D 5/00; G01N 27/26

(52) U.S. Cl. 427/198; 427/404; 204/403.01

(57) ABSTRACT

A method is provided to manufacture an electrochemical sensor that includes a strip with a receptacle formed therein, and a working electrode located in a wall of the receptacle. The method includes the steps of applying a working electrode layer onto a first insulating material, and applying a dielectric layer, formed by a first dielectric layer and a second dielectric layer, onto at least a part of the working electrode layer to form a laminate. A hole or well is created in the laminate, wherein the hole or well passes through the working electrode layer and a first surface of the laminate. The method further includes applying a pseudo reference electrode layer onto at least a part of the first surface of the laminate, and optionally attaching a base to a second surface of the laminate to produce a bonded article.

### CROSS-REFERENCE TO RELATED APPLICATIONS

This application claims benefit of U.S. Provisional Patent Application No. 60/586,834 filed Jul. 9, 2004.

### FIELD OF THE INVENTION

The present invention relates to a process for manufacturing an electrochemical sensor and a device obtained by this method.

### BACKGROUND TO THE INVENTION

Electrochemical cells containing microelectrodes, for example micro-band electrodes, are used for the electrochemical detection of various parameters of a substance. For example, such a cell may be used to detect, or measure the concentration of, a particular compound in a test substance. The use of electrochemical cells comprising microelectrodes as sampling devices brings a number of potential benefits including speed of operation, accuracy and minimal sample requirement. By using the microelectrodes in conjunction with enzymes or other electroactive substances it is possible to create sensors that provide quantitative measurement of target parameters through reactions with the corresponding electroactive substance.

An electrochemical cell which incorporates microelectrodes is described in WO 03/056319 (which document is hereby incorporated in its entirety by reference). The electrochemical cell described in this document comprises a well-like structure which incorporates the working electrode of the electrochemical cell in its walls. Typically, an enzyme or other electroactive substance is present in the well. The substance to be tested can be inserted into the well and, following reaction with the electroactive substance, electrochemical measurement carried out.

An object of the present invention is to provide a method of manufacturing electrochemical sensors of the type having a well-like structure in which the working electrode of the electrochemical sensor is in the wall of the well.

### SUMMARY OF THE INVENTION

Accordingly, the present invention provides a method of manufacturing an electrochemical sensor, said electrochemical sensor comprising a strip having a receptacle formed therein, a working electrode of the electrochemical sensor being located in a wall of the receptacle, the method comprising
applying a working electrode layer onto a first insulating material;
applying a dielectric layer, comprising a first dielectric layer and optionally one or more further dielectric layers, onto at least a part of the working electrode layer to form a laminate;
creating a hole or well in the laminate, the hole or well passing through the working electrode layer and a first surface of the laminate;
applying a pseudo reference electrode layer onto at least a part of the first surface of the laminate; and optionally
attaching a base to a second surface of the laminate to produce a bonded article.

The five steps are not necessarily carried out in the stated order, and alternative orders may be employed. In one embodiment, the steps are carried out in the stated order. In an alternative embodiment, the pseudo reference electrode layer is applied before creation of the hole or well. In a further embodiment, the pseudo reference electrode layer is applied after attachment of the base.

The method of the invention provides a technique by which the desired electrochemical sensors can be produced, the method comprising a number of discreet steps, each of which is simple to execute. The method of the present invention is also suitable for scaling-up to manufacture electrochemical sensors in bulk. The particular advantages associated with the various steps of the invention are discussed further below.

Also provided by the present invention is a device manufactured by the method of the invention.

### BRIEF DESCRIPTION OF THE FIGURES

FIG. 1 depicts an electrochemical sensor which can be produced by the process of the invention; and

FIGS. 2 and 3 schematically depict the process of the invention.

### DETAILED DESCRIPTION OF THE INVENTION

An electrochemical sensor comprises an electrochemical cell having at least two electrodes. When in use, the electrochemical sensor can be attached to a separate electronics unit which supplies a potential (or current) to the electrodes. Electrochemical reactions occurring at each of the electrodes cause electrons to flow to and from the electrodes, thus generating a current. An electrochemical sensor can thus be used to detect electrochemical reactions which are induced by an applied current or voltage.

Typically, the electrochemical sensor operates by applying a sample to the sensor such that the sample contacts the working electrode and other electrodes, causing a potential across the electrochemical cell and measuring the resulting current.

An electrochemical cell may be either a two-electrode or a three-electrode system. A two-electrode system comprises a working electrode and a pseudo-reference electrode. A three-electrode system comprises a working electrode, a pseudo reference electrode and a separate counter electrode. As used herein, a pseudo reference electrode is an electrode that is capable of providing a reference potential. In a two-electrode system, the pseudo reference electrode also acts as the counter electrode and is thus able to pass a current without substantially perturbing the reference potential. In a three-electrode system, the pseudo reference electrode typically acts as a true reference electrode and is, for example, a standard hydrogen or calomel electrode. The electrochemical sensors of the present invention typically comprise electrochemical cells having two electrodes.

As used herein, a microelectrode is an electrode having at least one dimension not exceeding 50 μm. A microelectrode may have a dimension which is macro in size, i.e. which is greater than 50 μm. A micro-band electrode has one dimension not exceeding 50 μm and one dimension substantially larger than 50 μm such that the surface of the electrode forms a thin strip or band.

As used herein, a receptacle is a component, for example a container, which is capable of containing a liquid placed into it.

As used herein, reference to applying a layer “onto” a further layer encompasses applying said layer directly onto said further layer, and applying said layer indirectly onto said further layer (i.e. where another layer or substance is located between said layer and said further layer).

The electrochemical sensor produced by the method of the present invention comprises a strip having a receptacle formed therein. The strip may have any shape or size. The working electrode of the electrochemical sensor is in a wall of the receptacle. Typically, the working electrode is a microelectrode. For example, in one embodiment the working electrode is a micro-band electrode.

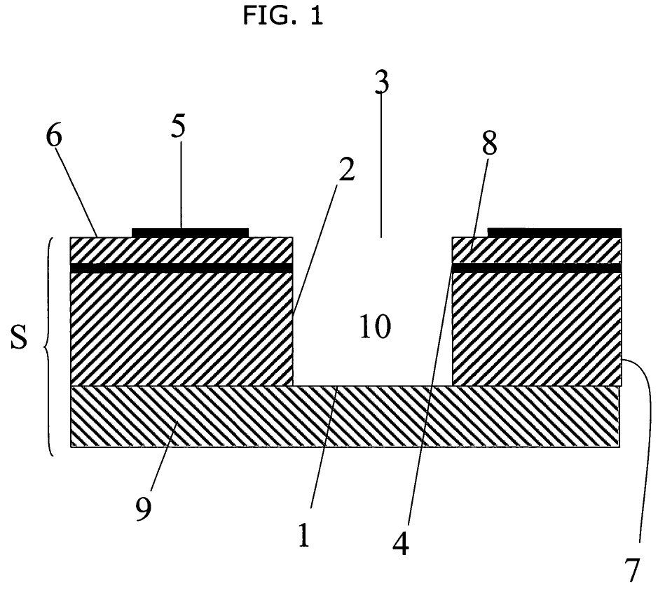

In one embodiment of the invention, the process provides a sensor as depicted in FIG. 1. The sensor comprises a strip S having a receptacle 10 formed therein. The receptacle in this embodiment has a base 1, walls 2 and a first open part 3. It is noted, however, that the present invention encompasses sensors in which the receptacle has a different shape, for example it may be a cone, truncated cone or a channel. The sensor comprises an electrochemical cell and the working electrode 4 of the electrochemical cell is located in the wall 2 of the receptacle. The device also comprises a pseudo reference electrode 5. In the depicted embodiment, the electrochemical cell is a two-electrode system with the pseudo reference electrode 5 on the surface 6 of the strip. In alternative embodiments a separate counter electrode may be provided.

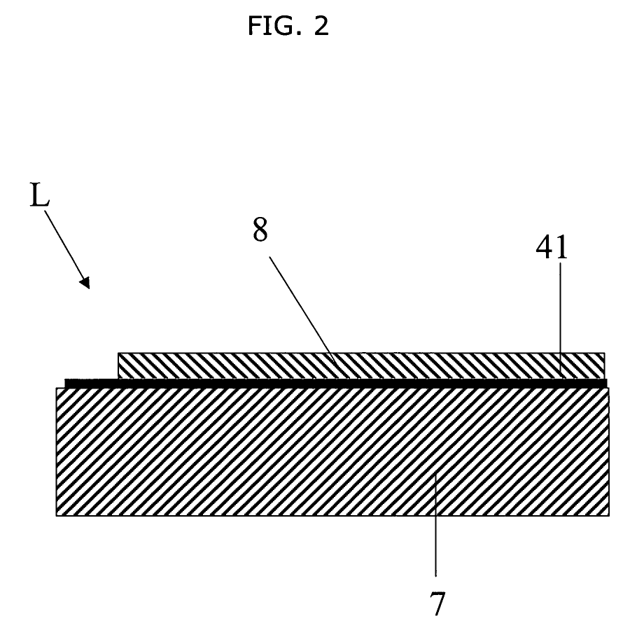

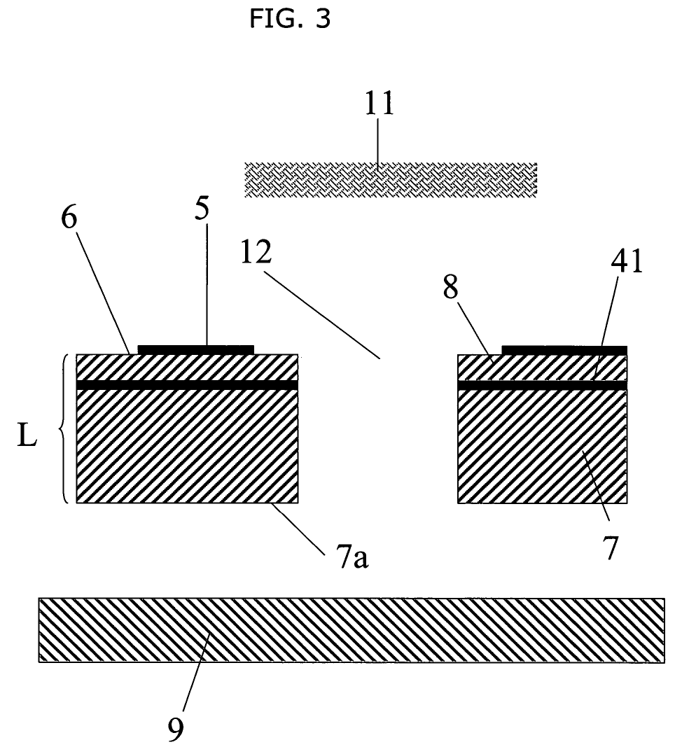

The method of the invention is depicted schematically in FIGS. 2 and 3. FIG. 2 depicts a laminate L, which is formed by applying a working electrode layer 41 onto a first insulating material 7, and subsequently applying a dielectric layer 8 onto at least a part of the working electrode layer.

The first insulating material 7 is typically formed of a polymer, for example, an acrylate, polyurethane, PET, polyolefin, polyester, PVC or any other stable insulating material, e.g. an acrylate, polyurethane, PET, polyolefin or polyester. Polycarbonate and other plastics and ceramics are also suitable insulating materials.

The working electrode layer 41 is typically printed onto the first insulating material 7. For example, an ink comprising the material to be used as the working electrode may be printed on to the insulating material. Examples of suitable printing techniques include screen printing, ink jet printing, thermal transfer or lithographic, intaglio or gravure printing, for example the techniques described in WO 02/076160 (the contents of which are incorporated herein in their entirety by reference). Printing the working electrode onto the insulating material is a simple way to provide the working electrode in the desired pattern and thickness. However, alternative application techniques that lead to μm thicknesses may also be employed.

The working electrode layer is preferably formed from carbon, palladium, gold, platinum, silver or copper, e.g. carbon, palladium, gold or platinum, in particular carbon, for example in the form of a conductive ink. The conductive ink may be a modified ink containing additional materials, for example platinum and/or graphite and/or an electrocatalyst (e.g. an enzyme) and/or a mediator. Examples of suitable electrocatalysts and mediators are described below with reference to the electroactive substance.

The working electrode layer may comprise a single layer, for example a carbon layer. Alternatively, two or more layers which are formed of the same or different materials, may be applied. For example, a layer of a material having a lower resistance than carbon may be applied and a carbon layer applied onto the lower resistance layer. Silver is an example of a suitable material having a lower resistance than carbon. Typically, the carbon layer is applied in substantially the same pattern as the lower resistance layer. As would be apparent to the skilled person, however, the lower resistance layer is not applied in the area which is to form the hole or well, such that formation of the hole or well exposes the carbon layer but does not expose the lower resistance layer.

The thickness of the working electrode layer is typically from 0.01 to 50 μm, for example 0.01 to 25 μm, preferably from 0.05 to 15 μm, for example 0.1 to 20 μm, more preferably from 0.1 to 10 μm. Thicker working electrode layers are also envisaged, for example thicknesses of from 0.1 to 50 μm, preferably from 5 to 20 μm.

The working electrode layer is typically applied in a chosen pattern. The pattern selected is one that ensures that at least a part of the working electrode layer is exposed when the hole is created. Electrically conducting tracks are also conveniently printed onto the first insulating material 7 in order to connect the working electrode to any desired electrical instruments, for example a potentiostat. The tracks may be made of any suitable conducting material, such as the material used for the working electrode layer itself. Typically, the working electrode layer itself forms both the working electrode and the electrically conducting tracks.

A dielectric layer 8 is then applied onto at least a part of the working electrode layer. The dielectric layer is typically applied in such a pattern that all of the working electrode layer is covered by dielectric layer, with the exception of the parts of the electrically conducting tracks that are required to mate with an electronics unit. In an alternative embodiment, a smaller proportion of the working electrode layer is covered by the dielectric layer. In this embodiment, for example, the dielectric layer covers the working electrode in the area of the strip surface onto which (a) sample is to be placed and (b) a pseudo reference electrode layer is to be applied. In other areas of the strip surface, which will not contact the sample or the pseudo reference electrode layer, the working electrode layer may remain exposed.

The dielectric layer is typically applied by printing, for example using the printing techniques mentioned above with respect to the working electrode layer. Other techniques for forming the dielectric layer include solvent evaporation of a solution of the insulating material or formation of an insulating polymer by a cross-linking mechanism. Alternatively, the dielectric layer may be formed by laminating a layer of insulating material to the working electrode layer, for example by thermal or pressure-sensitive lamination.

The dielectric layer is typically formed of a polymer, for example, an acrylate, polyurethane, PET, polyolefin, polyester or any other stable insulating material. Polycarbonate and other plastics and ceramics are also suitable insulating materials.

Typically, the dielectric layer comprises one, two or more, e.g. two, sub-layers (a first dielectric layer and optional further dielectric layers). Where only a single layer is used, pinholes may be present in the dielectric layer. This can lead to shorting of the electrodes if the pinhole(s) enable the working electrode layer and the pseudo reference or counter electrode layer to electrically contact one another. The application of two (or more) dielectric layers typically avoids this problem and therefore reduces the likelihood of electrode shorting. The first and optional further dielectric layers are typically applied in substantially the same pattern.

The dielectric layer typically has a thickness of from 2 to 60 μm, preferably from 6 to 50 μm. For example, each sub-layer may have a thickness of from 1 to 30 μm, preferably from 3 to 25 μm. In an alternative embodiment, the dielectric layer has a thickness of from 50 to 150 μm. This may, for example, be made up of several sub-layers having a thickness of up to 30 μm. Such thicker dielectric layers have in some instances been shown to lead to improved precision in the sensor response.

The thus formed laminate L typically has a thickness (i.e. the total thickness of the layers 7, 41 and 8) of from 50 to 1000 μm, preferably from 100 to 600 μm, for example from 150 to 400 μm.

The laminate L optionally comprises further layers in addition to the first insulating material, working electrode layer and dielectric layer. Such layers may, for example, be located between the first insulating material and working electrode layer, or between the working electrode layer and dielectric layer.

A hole or well is created in laminate L as depicted at 12 in FIG. 3. A hole passes completely through the laminate. In order to form a receptacle, it is therefore typically necessary to attach a base to the laminate. In contrast, a well does not pass through the laminate, but rather forms an indentation or well in the laminate such that a receptacle is directly formed in the laminate without the addition of a base. In either case, the hole or well passes through a first surface of the laminate and passes through the working electrode layer such that the edge of the working electrode layer is exposed. In the Figures, a hole is depicted in the laminate.

The hole or well may be created by any means suitable for producing holes of mm dimensions. For example, the hole or well may be punched or drilled or formed by die-cutting, ultra-sonic cutting, water-jet cutting, laser drilling or laser ablation, or a combination of these techniques. The hole or well typically has a width of from 0.1 to 5 mm, for example 0.5 to 2.0 mm, e.g. 0.5 to 1.5 mm, such as 1 mm. The width is defined as the maximum distance from wall to wall measured across the mid-point of the cross-section of the hole or well. In the case of a cylindrical hole or well, the width is the cross-sectional diameter.

The hole or well may be created in any desired shape. Examples of suitable shapes include cylindrical holes or wells and holes or wells having sloping walls such that the resulting receptacle or partial receptacle is in the shape of a cone or truncated cone. In the case of a cone or truncated cone-shaped hole or well, the above-mentioned widths are the typical widths of the first open part 3 of the receptacle thus formed. Alternatively, the hole or well may provide a receptacle in the form of a channel. For example, a channel may have a width of from about 100 to about 400 μm and a length of from 1 to 10 mm, for example 2 to 5 mm.

Creation of the hole or well exposes the working electrode. Preferably, the hole or well is created in such a position that the working electrode layer is exposed around the whole perimeter of the hole or well. In this case, the working electrode in the sensor produced is in the form of a continuous band around the wall of the receptacle. In a preferred embodiment, the working electrode exposed by the creation of the hole or well is a microelectrode. In a further preferred embodiment, the working electrode is a micro-band electrode.

The pseudo reference electrode layer 5 is applied onto at least a part of the first surface 6 of the laminate L. The first surface of the laminate is typically formed by the dielectric layer such that the pseudo reference electrode layer is applied onto the dielectric layer. However, in an alternative embodiment the first surface of the laminate is formed by the first insulating material such that the pseudo reference electrode layer is applied onto the first insulating material. The pseudo reference electrode is typically applied in an area close to, for example surrounding, the hole or well. The pseudo reference electrode layer is typically applied by printing an ink onto the laminate. Examples of suitable printing techniques are those mentioned above with reference to the formation of the working electrode layer. Alternative techniques may be used if desired.

The pseudo reference electrode layer is applied to the surface of the strip, typically close to the first open part 3. This has the advantage that a sample which is provided to the strip will typically contact the pseudo reference electrode without difficulty. However, it may be possible to reduce or avoid contact between the pseudo reference electrode and any electroactive substance which is placed into the receptacle. Since the pseudo reference electrode layer may be formed of silver or other materials which can cause enzymes to denature, this feature is particularly advantageous when an enzyme is to be present in the electroactive substance.

Furthermore, the location of the pseudo reference electrode on the surface of the strip enables a large surface area of electrode to be used. The pseudo reference electrode therefore has a large current carrying capacity, which helps to avoid the response of the device being limited by the pseudo reference electrode.

The pseudo reference electrode is typically made from Ag/AgSO₄, carbon, Ag/AgCl, palladium, gold, platinum, Hg/HgCl₂ or Hg/HgSO₄. It is preferably made from carbon, Ag/AgCl, palladium, gold, platinum, Hg/HgCl₂ or Hg/HgSO₄. Ag/AgCl is a preferred material. Each of these materials may be provided in the form of a conductive ink. The conductive ink may be a modified ink containing additional materials, for example platinum and/or graphite and/or an electrocatalyst (e.g. an enzyme) and/or a mediator. Examples of suitable electrocatalysts and mediators are described below with reference to the electroactive substance. Ag/AgCl is a preferred material for the pseudo reference electrode layer.

The thickness of the pseudo reference electrode layer is typically similar to or greater than the thickness of the working electrode. Suitable minimum thicknesses are 0.1 μm, for example 0.5, 1, 5 or 10 μm. Suitable maximum thicknesses are 50 μm, for example 20 or 15 μm.

The pseudo reference electrode layer may be applied either before or after the hole or well is created. If the pseudo reference electrode layer is applied before the hole or well is created, it is preferred that the hole or well does not pass through the pseudo reference electrode layer. Thus, the hole or well is typically formed through a gap in the pseudo reference electrode layer. This helps to avoid the pseudo reference electrode layer being drawn into the hole or well and being smeared on the walls created. This, in turn, reduces the likelihood of electrode shorting. This also helps to prevent contamination of any machinery (e.g. punching or drilling tools) used to form the hole or well. Such contamination of machinery can lead to contamination of, for example, the working electrode layer in subsequently formed holes and wells.

Further, as mentioned above, it is desirable to avoid contact between the electroactive substance and the pseudo reference electrode in particular where enzymes are present in the electroactive substance. If material for the pseudo reference electrode is present on the walls of the receptacle, contact with the enzyme may occur and this can lead to denaturing of the enzyme. Where enzymes are used, it is therefore particularly preferred that the hole or well does not pass through the pseudo reference electrode layer.

In an alternative embodiment, the pseudo reference electrode layer is applied after the hole or well has been formed, thus avoiding the difficulties of the pseudo reference electrode layer being drawn down onto the walls of the hole or well. This embodiment also avoids the difficulties of aligning the hole or well with a gap in the pseudo reference electrode layer.

After forming the hole or well, a base 9 may be attached to the second surface 7a of the laminate (see FIG. 3). Where a hole is created in the laminate, a base is typically used so that a receptacle is formed at the position of the hole. However, where a well is created in the laminate, the step of attaching a base can be omitted.

The base is typically a second insulating material which comprises, for example, a polymeric sheet. Appropriate polymers are those described with reference to the first insulating material. The base is optionally surface treated in order to provide particular properties to the surface which forms the base of the receptacle, e.g. a hydrophobic or hydrophilic surface treatment may be used. Alternatively, the base may itself be formed from a hydrophilic or hydrophobic porous membrane. Versapor by Pall Filtration is an example of an appropriate porous membrane.

The base is typically attached to the first insulating material as depicted in FIGS. 1 and 3. In an alternative embodiment, the base is attached to the dielectric layer. In this latter embodiment, the laminate L has a first surface 6 which is formed by the first insulating material and a second surface 7a which is formed by the dielectric layer.

The attachment of the base may be carried out either before or after the pseudo reference electrode layer has been applied. Attachment of the base may be carried out by any suitable technique, for example, using pressurized rollers. A heat sensitive adhesive may be used, in which case an elevated temperature is needed. Room temperature can be used for pressure sensitive adhesive.

Attachment of the base forms a bonded article having a receptacle 10 at the location of the hole.

The receptacle formed typically has a volume of from 0.1 to 5 μl, for example from 0.1 to 3 μl or from 0.2 to 1 μl.

In one embodiment of the invention, an electroactive substance is inserted into the thus formed receptacle. An electroactive substance is any substance which is capable of causing an electrochemical reaction when it comes into contact with a sample. Thus, on insertion of the sample into the cell and contact of the sample with the electroactive substance, electrochemical reaction may occur and a measurable current, voltage or charge may occur in the cell. The electroactive substance may, for example, comprise an electrocatalyst and/or a mediator. Suitable electrocatalysts are well known to those of skill in the art and include various metal ions (e.g. cobalt), and various enzymes (e.g. lactate oxidase, cholesterol dehydrogenase, glycerol dehydrogenase, lactate dehydrogenase, glycerol kinase, glycerol-III-phosphate oxidase and cholesterol oxidase). Examples of suitable mediators are ferricyanide/ferrocyanide and ruthenium compounds such as ruthenium (III) hexamine salts (e.g. the chloride salt).

The electroactive substance is inserted into the receptacle, for example, using micropipetting or ink jet printing. Micropipetting is, in one embodiment, carried out using Allegro Technologies Ltd.'s spot-on™ technology or a similar technique. The electroactive substance may then be dried by any suitable technique, for example air drying, freeze drying, oven baking or vacuum drying.

In a preferred embodiment, one or more vent holes are created in the receptacle. These vent holes enable displaced air to escape from the receptacle when a liquid sample enters the receptacle. Typically, a single vent hole is created in the base of the receptacle (for example, in the second insulating material), although any number of (e.g. up to 4) holes may be present if desired. The vent holes may be located other than in the base of the receptacle if desired. The vent hole may be produced by any technique, including mechanical drilling or punching, laser drilling, water-jet cutting or ultra-sonic cutting. The vent holes typically have capillary dimensions, for example, they may have an approximate diameter of 1-600 μm, for example from 100 to 500 μm, preferably from 150-250 μm. The vent holes should be sufficiently small that a liquid sample placed into the receptacle is substantially prevented from leaving the receptacle through the vent holes due to surface tension.

The vent hole(s) may be created either before or after attachment of the base (if used). Further, the vent hole(s) may be created either before or after insertion of an electroactive substance into the receptacle. In one embodiment, the vent hole(s) are produced prior to attaching the base. The production of the hole(s) in this embodiment is straightforward and handling is easy since the base is not, at that stage, attached to any further parts. However, this embodiment has the disadvantage that the thus formed vent hole(s) must be correctly lined up with the hole in the first insulating material such that the vent hole(s) are correctly positioned in the base of the receptacle.

In an alternative embodiment, the electroactive substance is inserted into the receptacle and dried, and vent hole(s) are then created which pass through the base of the receptacle as well as through the dried electroactive substance. In this way, the vent hole(s) are not blocked by the electroactive substance.

If desired, a permeable or semi-permeable membrane 11 may then be placed over the receptacle. The membrane is preferably made of a material through which the sample to be tested can pass. For example, if the sample is plasma, the membrane should be permeable to plasma. Suitable materials for use as the membrane include polyester, cellulose nitrate, polycarbonate, polysulfone, microporous polyethersulfone films, PET, cotton and nylon woven fabrics, coated glass fibres and polyacrylonitrile fabrics. These fabrics may optionally undergo a hydrophilic or hydrophobic treatment prior to use. Other surface characteristics of the membrane may also be altered if desired. For example, treatments to modify the membrane's contact angle in water may be used in order to facilitate flow of the desired sample through the membrane.

The membrane may comprise one, two or more layers of material, each of which may be the same or different, e.g. two different membranes having different functionality may be used. For example, conventional double layer membranes comprising two layers of different membrane materials may be used. In another embodiment the membrane comprises a wetting membrane and a blood filtration membrane. Petex is an appropriate wetting membrane whilst preferred filtration membranes are described below. In one embodiment the membrane comprises a petex layer and a Pall BTS layer.

The membrane may also be used to filter out some components which are not desired to enter the receptacle. For example, some blood products such as red blood cells or erythrocytes may be separated out in this manner such that these particles do not enter the receptacle. Suitable filtration membranes, including blood filtration membranes, are known in the art. Examples of blood filtration membranes are Presence 200 of Pall filtration, Whatman VF2, Whatman Cyclopore, Spectral NX, Spectral X and Pall BTS, e.g. Presence 200 of Pall filtration, Whatman VF2, Whatman Cyclopore, Spectral NX and Spectral X. Fibreglass filters, for example Whatman VF2, can separate plasma from whole blood and are suitable for use where a whole blood specimen is supplied to the device and the sample to be tested is plasma. An active membrane which removes LDL from the blood can also be used.

The membrane is typically attached to the surface of the strip using any type of adhesive which is suitable for attachment of the membrane. For example, double sided adhesive, or screen printed pressure sensitive adhesive may be used. Attachment of the membrane may, for example, be carried out by using a pressure sensitive adhesive (which has been cast) that has been die cut to remove the adhesive in the area over the receptacle, and typically over a wider working area.

Alternatively, a single sided adhesive may be used to attach the edges of the membrane to the surface of the strip. The membrane is typically attached to the dielectric layer and/or to the pseudo reference electrode layer.

In one embodiment, the adhesive is cut or shaped to ensure that no adhesive is present over the working area of the sensor, i.e. the area of the receptacle, and the area of the strip surrounding the receptacle which is to contact the sample. This ensures that at least a part of the surface of pseudo reference electrode layer 5 around open part 3 is not covered with adhesive and will contact any sample which passes through membrane 11.

The laminate or, where a base is attached the bonded article, may then be profile cut to provide a strip having the desired profile. The profile cutting step can be carried out by any known cutting method. It is noted that the profile cutting step is not essential and where no profile cutting step is used, the laminate or bonded article is itself the strip of the electrochemical sensor.

In use, the strip of the electrochemical sensor is typically connected to an electronics unit which comprises a potentiostat to apply the required voltage to the electrodes. Typically, the strip is partially inserted into a designated slot in the electronics unit, where the electrodes of the strip will mate with electrical connections in the electronics unit. In order to ensure correct connection of the electrodes with the electrical connections in the electronics unit, accurate positioning of the strip is desirable. This can, for example, be achieved by profile cutting the strip to a specified design that will fit into the required position in the slot in the electronics unit.

The process of the invention typically comprises creating two or more, preferably at least four, holes or wells in the first insulating material such that at least two, preferably at least four, receptacles are formed in the strip. In this way, an electrochemical sensor having several electrochemical cells can be produced. By applying the working electrode layer in a suitable pattern, each receptacle can have its own working electrode with electrical tracks to connect it to the required instruments. A separate pseudo reference electrode may be provided for each receptacle, or a single pseudo reference electrode may be used for all receptacles.

Each receptacle may contain the same or different electroactive substance such that when a sample is inserted into each receptacle, several different tests may be carried out or the same test may be repeated several times in order to detect or eliminate errors in the measurements taken. Furthermore, each electrochemical cell present in the sensor may be set at different potentials, again providing different measurements for the same sample.

The present invention can be scaled up so that more than one electrochemical sensor is produced at once. For example, a batch process may be used in which the first insulating material comprises a sheet in which a large number of holes or wells, for example at least 10, at least 20 or at least 50 holes or wells are produced. The holes or wells may each be produced separately, or two or more holes or wells (for example at least four holes or wells, or all of the holes or wells be to created in each sheet) may be produced substantially simultaneously in a single step. Following the optional attachment of a base (e.g. a sheet of second insulating material), at least 10, 20 or 50 receptacles are provided. The remaining steps of the process are carried out as described above, but typically applying each step to the entire sheet, for example by applying each step substantially simultaneously to the entire sheet. The laminate or bonded article thus produced is then profile cut to produce a plurality of separate strips, each having one or more receptacles formed therein.

In an alternative embodiment, a continuous process may be used to produce the electrochemical sensors. In this embodiment, for example, the first insulating material may be provided in the form of a sheet wound onto a reel or web. The continuous process comprises applying each of the steps of the above-described process in a continuous manner. As for the batch process, the continuous process comprises profile cutting the thus-produced laminate or bonded article to provide a plurality of individual strips, each having one or more receptacles formed therein.

The electrochemical sensors produced by the process of the invention are then typically packaged. For example, each sensor may be individually packaged in a metal foil that can easily be removed by the user prior to use. A dessicant may be included in the packaging, although preferably the dessicant does not contact the sensor itself. The presence of a dessicant helps to keep the electroactive substance in good condition during storage. Suitable dessicants are molecular sieves, silica gel and activated alumina, e.g. molecular sieves.

A calibration step may also be included in the process of the invention. Calibration can be carried out by known techniques in the art, and the precise methods to be used will depend on the electroactive substance present in the receptacle(s). Calibration may be carried out at any stage after the electroactive substance has been inserted into the receptacle. Typically, calibration will take place after profile cutting. The calibration data may, for example, be provided in the form of a bar code on the packaging.

The electrochemical sensors produced by the invention can be used in an electrochemical sensing method by inserting a sample for testing into the or each receptacle, applying a potential between working and pseudo reference or counter electrodes and measuring the resulting current. In this way, the sensor may be used for determining the content of various substances in the sample. The sensor may, for example, be used to determine the pentachlorophenol content of a sample for environmental assessment; to measure cholesterol, HDL, LDL and triglyceride levels for use in analysing cardiac risk, or for measuring glucose levels, for example for use by diabetics. A further example of a suitable use for the sensor of the invention is as a renal monitor for measuring the condition of a patient suffering from kidney disease. In this case, the sensor could be used to monitor the levels of creatinine, urea, potassium and sodium in the urine. The sensor can also be used to determine whether a blood or plasma sample is ischemic.

The invention has been described above with reference to various specific embodiments. However, it is to be understood that the invention is not limited to these specific embodiments.

1. A method of manufacturing an electrochemical sensor, said electrochemical sensor comprising a strip having a receptacle formed therein, a working electrode of the electrochemical sensor being located in a wall of the receptacle, the method comprising
applying a working electrode layer onto a first insulating material;
applying a dielectric layer, comprising a first dielectric layer and optionally one or more further dielectric layers, onto at least a part of the working electrode layer to form a laminate;
creating a hole or well in the laminate, the hole or well passing through the working electrode layer and a first surface of the laminate;
applying a pseudo reference electrode layer onto at least a part of the first surface of the laminate; and optionally
attaching a base to a second surface of the laminate to produce a bonded article.

2. A method according to claim 1, wherein the working electrode layer has a thickness of no more than 50 μm such that the working electrode formed in the wall of the receptacle is a microelectrode.

3. A method according to claim 1, wherein the hole or well has a width of from 0.1 to 5 mm.

4. A method according to claim 1, wherein the working electrode layer is applied by (a) printing a layer of carbon onto the first insulating material, or (b) printing a layer of silver onto the first insulating material, and printing a layer of carbon onto the layer of silver.

5. A method according to claim 1, wherein the dielectric layer is applied by printing a first dielectric layer onto at least a part of the working electrode layer, printing a second dielectric layer onto the first dielectric layer and optionally printing one or more further dielectric layers onto the second dielectric layer.

6. A method according to claim 1, wherein the pseudo reference electrode layer is applied (a) before or (b) after creating the hole or well.

7. A method according to claim 1, wherein the pseudo reference electrode layer is applied by printing a layer of silver/silver chloride onto at least a part of the first surface of the laminate.

8. A method according to claim 1, wherein the base is laminated to the second surface of the laminate.

9. A method according to claim 1, which comprises creating two or more holes or wells in the laminate, such that two or more receptacles are formed.

10. A method according to claim 1, which further comprises dispensing an electroactive substance into the receptacle and optionally drying the electroactive substance.

11. A method according to claim 9, which further comprises dispensing an electroactive substance into one or more receptacles and optionally drying the electroactive substance.

12. A method according to claim 10, which further comprises creating one or more vent holes to allow displaced air to escape from the receptacle when a liquid sample enters the receptacle.

13. A method according to claim 11, which further comprises creating one or more vent holes to allow displaced air to escape from the receptacle(s) when a liquid sample enters the receptacle.

14. A method according to claim 12, which further comprises placing a membrane over at least a part of an open part of the receptacle.

15. A method according to claim 13, which further comprises placing a membrane over at least a part of an open part of one or more receptacles.

16. A method according to claim 1, wherein the base is surface-treated to render it hydrophobic or hydrophilic, or wherein the base is formed of a hydrophilic or hydrophobic porous membrane.

17. A method according to claim 1 wherein ten or more holes or wells are created in the laminate such that ten or more receptacles are formed, and wherein the method further comprises profile cutting the laminate or bonded article to produce two or more strips, each strip having one or more receptacles formed therein.

18. A method according to claim 15, wherein ten or more holes or wells are created in the laminate such that ten or more receptacles are formed, and wherein the method further comprises profile cutting the laminate or bonded article to produce two or more strips, each strip having one or more receptacles formed therein.

19. A device manufactured according to the method of claim 1.

20. A device manufactured according to the method of claim 18.
